(19) United States
(12) Patent Application Publication
(10) Pub. No.: US 2006/0226964 A1
(43) Pub. Date: Oct. 12, 2006

(54) DUAL COLOR LED SCHOOL BUS WARNING LIGHT

(76) Inventor: SCOTT ARTHUR RIESEBOSCH, WELLAND (CA)

Correspondence Address: SCOTT RIESEBOSCH, 129 HAGAR ST., UNIT # 5, WELLAND, ON, L3B-5V9, CA

(21) Appl. No.: 10/907,048

(22) Filed: Mar. 17, 2005

(51) Int. Cl. B60Q 1/26

(52) U.S. Cl. 340/433

(57) ABSTRACT

There is provided a new and useful invention for use on a school bus that reduces the cost of manufacturing the bus as well as the warning lights. Combining the functionality of the red warning lights and the amber warning lights into a lighting package where each light can emit both red and amber colors reduces the number of warning lights required on a school bus from eight warning lights to four warning lights or less. The dual color functionality can be achieved using light emitting diodes and appropriate optical design methods.

### FIED OF THE INVENTION

This invention relates to the construction of a school bus warning light that can produce both red and amber light using light emitting diodes.

### BACKGROUND OF THE INVENTION

School buses have always been equipped with either four amber warning lights and four red warning lights, or four red warning lights. These lamps have traditionally been incandescent, filament bulbs, halogen bulbs, and have recently evolved to xenon strobe tubes and light emitting diode light sources. All school bus warning lights have been designed and manufactured as single color lights, either amber or red. Most school buses in service are outfitted with four amber warning lights and four red warning lights. This traditional approach requires manufacturers to build eight light housings, eight light sources, and it requires school bus manufacturers to cut eight holes, run wiring for eight lamps, and physically install eight separate lamps. This is a cumbersome, wasteful approach.

There exists a need to streamline the warning light system on school buses by effectively reducing number of physical lights required and thus reducing associated issues, while maintaining the required performance of four amber lights and four red lights.

### SUMMARY OF THE INVENTION

It is thus the object of the present invention to provide a school bus warning light capable of producing both red and amber light, utilizing light emitting diode technology. The invention would allow school bus manufacturers to cut labor and parts costs while maintaining and possibly improving safety. Each light would contain light emitting diodes arranged in a pattern that would allow the light to produce amber light when the school bus is slowing down, and red light when the school bus has stopped.

What is claimed is:

1. A school bus warning light capable of producing both red and amber light utilizing light emitting diodes as the light source.

2. A school bus warning light utilizing light emitting diodes as the light source and having a clear, colorless outer lens.
